(19) United States
(12) Patent Application Publication
(10) Pub. No.: US 2008/0250206 A1
(43) Pub. Date: Oct. 9, 2008

(54) STRUCTURE FOR USING BRANCH PREDICTION HEURISTICS FOR DETERMINATION OF TRACE FORMATION READINESS

(76) Inventors: Gordon T. Davis, Chapel Hill, NC (US); Richard W. Doing, Raleigh, NC (US); John D. Jabusch, Cary, NC (US); M.V.V. Anil Krishna, Cary, NC (US); Brett Olsson, Cary, NC (US); Eric F. Robinson, Raleigh, NC (US); Sumedh W. Sathaye, Cary, NC (US); Jeffrey R. Summers, Raleigh, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/116,696

(22) Filed: May 7, 2008

Related U.S. Application Data
(63) Continuation-in-part of application No. 11/538,831, filed on Oct. 5, 2006.

(51) Int. Cl. G06F 12/00

(52) U.S. Cl. 711/125; 711/E12.001

(57) ABSTRACT

A design structure embodied in a machine readable storage medium for designing, manufacturing, and/or testing a design for a single unified level one instruction(s) cache in which some lines may contain traces and other lines in the same congruence class may contain blocks of instruction(s) consistent with conventional cache lines is provided. Formation of trace lines in the cache is delayed on initial operation of the system to assure quality of the trace lines stored.

### CROSS-REFERENCE TO RELATED APPLICATION

This application is a continuation-in-part of co-pending U.S. patent application Ser. No. 11/538,831, filed Oct. 5, 2006, which is herein incorporated by reference.

### BACKGROUND OF THE INVENTION

### Field of the Invention

This invention is generally related design structures, and more specifically, design structures for the utilization of caches in computer systems.

Traditional processor designs make use of various cache structures to store local copies of instruction(s) and data in order to avoid the lengthy access times of typical DRAM memory. In a typical cache hierarchy, caches closer to the processor (level one or L1) tend to be smaller and very fast, while caches closer to the DRAM (level two or L2; level three or L3) tend to be significantly larger but also slower (longer access time). The larger caches tend to handle both instruction(s) and data, while quite often a processor system will include separate data cache and instruction(s) cache at the L1 level (i.e. closest to the processor core).

All of these caches typically have similar organization, with the main difference being in specific dimensions (e.g. cache line size, number of ways per congruence class, number of congruence classes). In the case of an L1 instruction(s) cache, the cache is accessed either when code execution reaches the end of the previously fetched cache line or when a taken (or at least predicted taken) branch is encountered within the previously fetched cache line. In either case, a next instruction(s) address is presented to the cache. In typical operation, a congruence class is selected via an abbreviated address (ignoring high-order bits), and a specific way within the congruence class is selected by matching the address to the contents of an address field within the tag of each way within the congruence class. Addresses used for indexing and for matching tags can use either effective or real addresses depending on system issues beyond the scope of this discussion. Typically, low order address bits (e.g. selecting specific byte or word within a cache line) are ignored for both indexing into the tag array and for comparing tag contents. This is because for conventional caches, all such bytes/words will be stored in the same cache line.

Recently, Instruction(s) Caches that store traces of instruction(s) execution have been used, most notably with the Intel Pentium 4. These “Trace Caches” typically combine blocks of instruction(s) from different address regions (i.e. that would have required multiple conventional cache lines). The objective of a trace cache is to handle branching more efficiently, at least when the branching is well predicted. The instruction(s) at a taken branch target address is simply the next instruction(s) in the trace line, allowing the processor to execute code with high branch density just as efficiently as it executes long blocks of code without branches. This type of trace cache works very well as long as branches within each trace execute as predicted. At the start of operation, however, there is no branch history from which to make predictions.

Even after a large number of cycles some branches may not have executed enough times to allow a reliable prediction, leading to formation of trace lines that frequently mispredict program execution. To avoid polluting the cache with such poorly predicted trace lines, the cache can begin execution forming conventional cache lines. Once significant branch history has been accumulated, trace lines can be formed and allowed to replace the conventional lines in the cache. While the conventional cache line mode can be run for a pre-chosen number of cycles, this may cause some well-predicted trace lines to be thrown away during those cycles, and some poorly-predicted trace lines to be used in the time after those cycles. What is needed is an effective mechanism to determine when enough branch history has been accumulated to switch to trace formation mode and achieve better performance than with conventional cache lines.

One limitation of trace caches is that branch prediction must be reasonably accurate before constructing traces to be stored in a trace cache. Switching to trace cache mode before such time will lead to frequent branch mispredicts. This can result in repeated early exits from a trace line when, for example a branch positioned early in a trace was predicted not taken when the trace was constructed, but is now consistently taken. Any instruction(s) beyond this branch are never executed, essentially becoming unused overhead that reduces the effective utilization of the cache. Since the branch causing the early exit is unanticipated, significant latency is encountered (branch misprediction penalty) to fetch instruction(s) at the branch target.

### SUMMARY OF THE INVENTION

One intention of this invention is to avoid the inefficiencies described above by defining an effective means to determine when branch prediction is consistent enough to warrant the switch to trace cache mode. This disclosure sets out three main methods for making this determination:

Wait a set number of cycles or instruction(s) to switch to trace formation mode;

Wait until the stored branch history reaches some threshold of predictability; or

Wait until the window of previously executed branches reaches some threshold of correct predictions.

In one embodiment, a design structure embodied in a machine readable storage medium for at least one of designing, manufacturing, and testing a design is provided. The design structure generally includes an apparatus, which may include a computer system central processor, and layered memory operatively coupled to said central processor and accessible thereby, said layered memory having a level one cache. The level one cache can store in interchangeable locations for both standard cache lines and trace lines, wherein the storage of a trace line can be delayed for a predetermined interval until such time as branch prediction is deemed sufficiently consistent.

### BRIEF DESCRIPTION OF THE DRAWINGS

Some of the purposes of the invention having been stated, others will appear as the description proceeds, when taken in connection with the accompanying drawings, in which:

FIG. 1 is a schematic representation of the operative coupling of a computer system central processor and layered memory which has level 1, level 2 and level 3 caches and DRAM;

FIG. 2 is a schematic representation of the organization of a L1 cache instruction(s) cache; and

FIG. 3 is a flow chart depicting the processes involved in the operation of a level 1 instruction(s) cache in accordance with this invention.

FIG. 4 is a flow diagram of a design process used in semiconductor design, manufacture, and /or test.

### DETAILED DESCRIPTION OF THE INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

Discussion now turns to the three general approaches to the determination of trace formation readiness mentioned above. They are listed above in increasing order of complexity, with each step giving a more granular approach to the determination of trace formation readiness. While this granularity does not guarantee better trace cache performance, in most cases it should give a more accurate view of the current branch predictability for the code in execution. While only the second and third mentioned approaches require any knowledge of branch execution, actual trace formation requires that same knowledge

Concerning the use of a set number of cycles/instruction(s), this approach keeps a simple counter that increments with each cycle or instruction(s) executed. When the counter reaches a preset threshold trace formation begins. While this is a simple method, it provides no means of adjusting the start of trace formation based on the code in execution.

Concerning the use of a branch history table (BHT), most BHT implementations keep not only a prediction of taken or fall-through for executed branches, but also a strength of that prediction. This method would use some metric of the strength of each prediction in the BHT to determine trace formation readiness. An example would be a threshold for the number of BHT entries that are at or above a certain strength of prediction. The complexity of the threshold being checked is dependent on the granularity of the prediction strength in the BHT, with more granularity in the stored prediction strength allowing for a more accurate view of the current branch predictability.

Concerning previous prediction accuracy, this approach tracks the accuracy of branch predictions as those branches execute, and uses that information to determine trace formation readiness. An example of this method would use a counter that incremented with execution of each correctly predicted branch, and would begin trace formation when that counter reached a preset value. However, even code with poorly predicted branches would eventually meet that threshold. A better method would be an up-down counter, which increments with execution of each correctly predicted branch but decrements with execution of each incorrectly predicted branch. Again, trace formation would begin once a preset value was met.

The term “programmed method,” as used herein, is defined to mean one or more process steps that are presently performed; or, alternatively, one or more process steps that are enabled to be performed at a future point in time. The term programmed method contemplates three alternative forms. First, a programmed method comprises presently performed process steps. Second, a programmed method comprises a computer-readable medium embodying computer instruction(s) which, when executed by a computer system, perform one or more process steps. Third, a programmed method comprises a computer system that has been programmed by software, hardware, firmware, or any combination thereof to perform one or more process steps. It is to be understood that the term programmed method is not to be construed as simultaneously having more than one alternative form, but rather is to be construed in the truest sense of an alternative form wherein, at any given point in time, only one of the plurality of alternative forms is present.

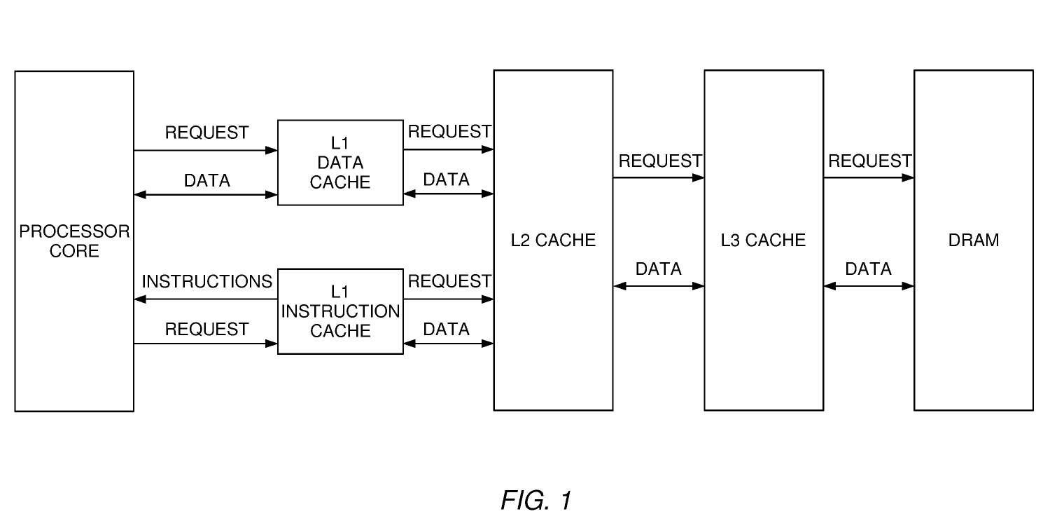

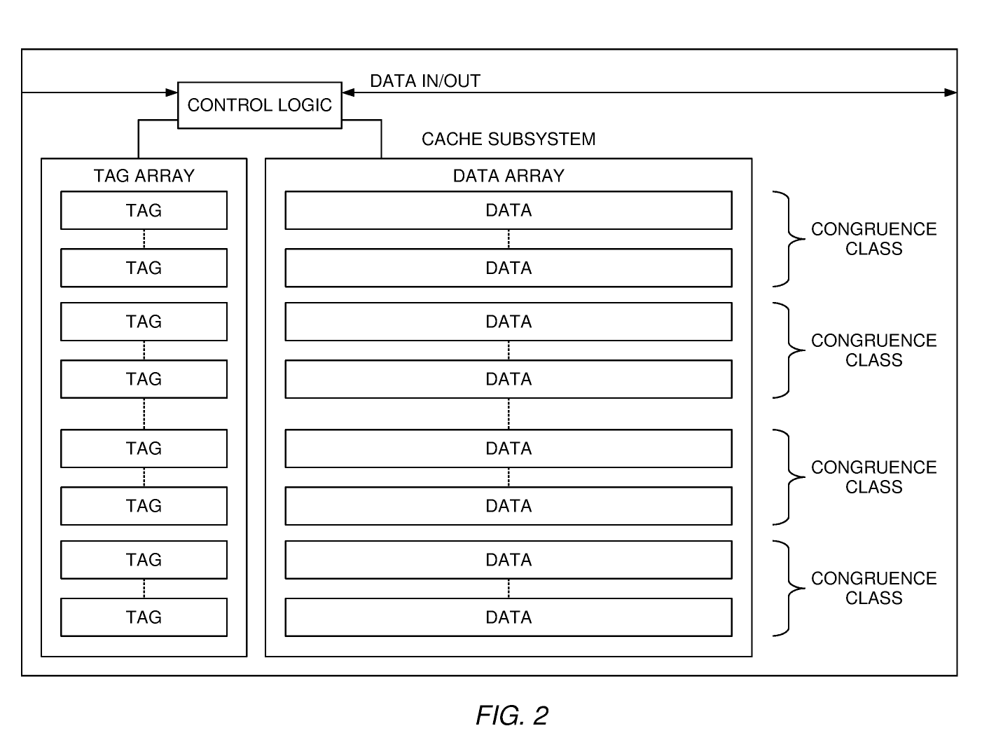

The processes and methods here particularly described proceed in the context of an L1 Instruction(s) cache coupled to a computer system processor as shown in FIG. 1 and which has 2^{L} bytes per line, M ways per congruence class, and 2^{N} congruence classes, and in which the instruction(s) address presented to the cache subsystem (FIG. 2) (branch target or flow-through from previous cache line) will be partitioned into the following fields:

a. Least significant L bits (address byte within line)

b. Next N bits (index into a specific congruence class)

c. Most significant bits

A typical implementation might have L=6 (16 instruction(s) or 64 bytes per line), M=4 ways per congruence class, and N=7 (128 congruence classes), for a total cache size of 32 KBytes. A typical implementation might also partition each cache line into multiple segments. For instance, a 64 byte line might be made up of data from 4 different arrays (16 bytes or 4 instruction(s)s per array). The motivation for this partitioning is that in some cases the required data can be accessed without powering up the entire cache line, thus saving power.

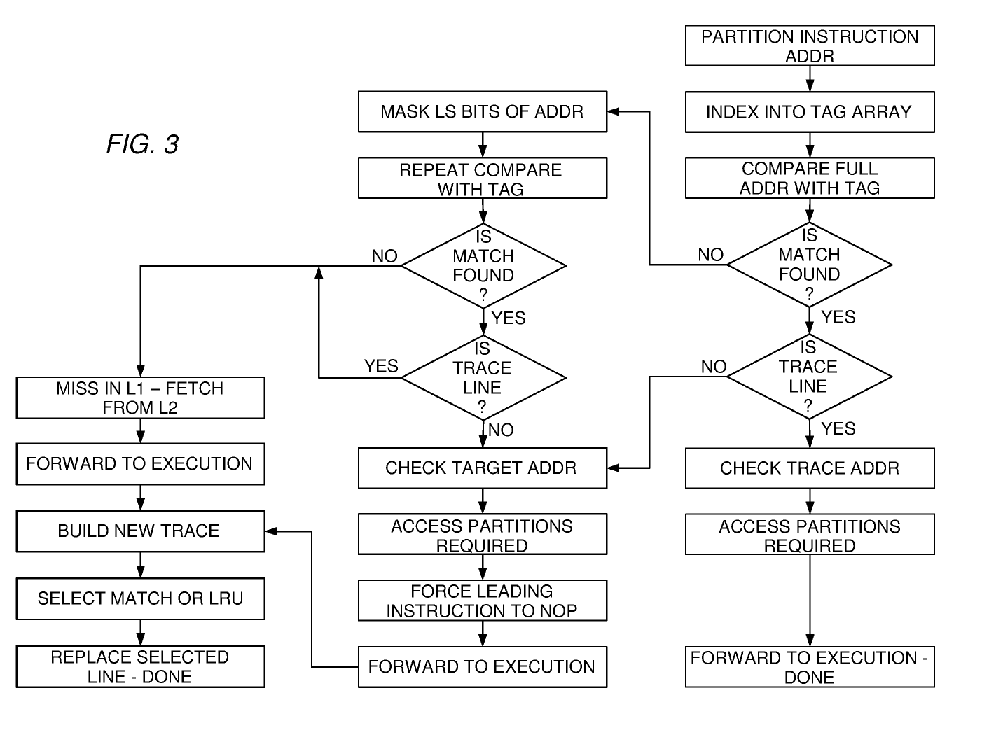

The process for accessing the cache then includes the following steps as illustrated in the flow chart of FIG. 3:

Take the N bits in the middle partition of the target instruction(s) address for use as an index into the tag array.

For each of the M entries in the tag array from the congruence class selected in step 1, compare the tag field with the full target instruction(s) address.

If match is found, is it a trace line?

If it is a trace line, check the trace length parameter in the tag. Enable only the partitions in the data array required to access the trace contents.

Access cache line from data array and forward trace to execution pipelines and exit process. (Only one cache line is allowed in cache with the same starting address). This may be either a trace line or conventional cache line.

In the case of a conventional cache line, it is found during this step only if the target instruction(s) address points to the first instruction(s) of the cache line.)

If no match is found, mask off (to zeros) the L least significant bits of the target instruction(s) address.

Repeat the compare with the tags within the selected congruence class. If a match is found, validate that it is a conventional cache line (i.e. with execution starting somewhere other than the first instruction(s)). Note that if it is a trace line with a starting address with zeros in least-significant bits, it is not the trace line that matches the branch target, and can't be used.

Access cache line from data array. Use least significant L bits from the target instruction(s) address to select only the target partition of the data array. This skips groups of instruction(s) with addresses lower than the branch instruction(s) in increments equal to the data array partition size (e.g. 4 instruction(s)).

Overlay instruction(s) to the left of the branch target instruction(s) (within the same partition as the branch target) with an indication of invalid instruction(s) (force to NOP). Then forward instruction(s) to execution pipelines. If no match is found, declare a miss in the L1 cache, and fetch the target address from the L2 cache.

Then build a new trace line, select a match or least recently used (LRU), and replace the selected line.

In order to insure proper operation, certain rules must be enforced when adding a line (either conventional or trace) to the cache:

If the address of the first instruction(s) in the line to be added matches the tag of a line already in the cache, that matching line must be removed in order to add the new line. This insures that a tag will be unique. If there is no match in tags, then the least recently used line (as indicated by LRU or pseudo-LRU) is replaced by the new line.

In accordance with this invention, the building of trace lines is deferred during initial operation of the system. That is, the building of trace lines in the L1 cache is delayed until such time as branch prediction is sufficiently consistent to warrant that step. Thus an additional step is inserted into the process described with reference to FIG. 3. One such approach simply uses a counter to determine that a predetermined number of cycles or processor operation or of executed instruction(s) has been reached. Another approach sets a threshold in a branch history table for predictability of branch instruction(s), and begins trace formation when that threshold is reached. Another approach records the execution of branches and identifies when a sliding window of such executed branches reaches a predetermined threshold of correct predictions. The method described in connection with FIG. 3 is modified by the insertion of a selected one of these delay procedures or such other comparable process as may be defined.

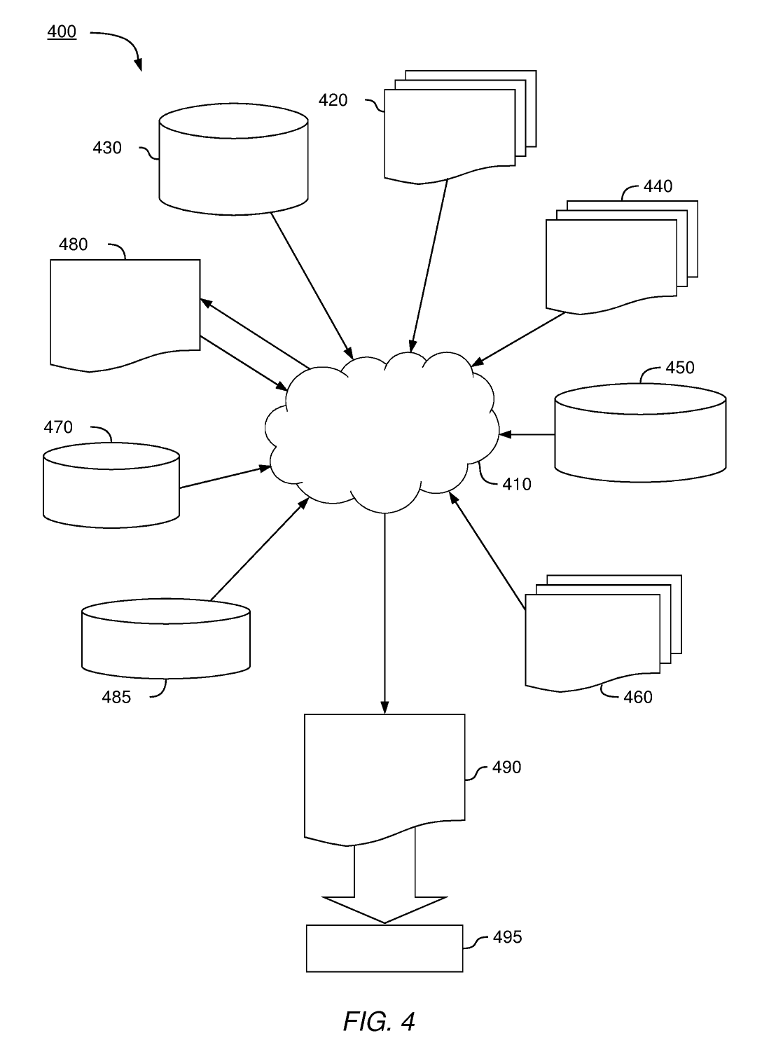

FIG. 4 shows a block diagram of an exemplary design flow 400 used for example, in semiconductor design, manufacturing, and/or test. Design flow 400 may vary depending on the type of IC being designed. For example, a design flow 400 for building an application specific IC (ASIC) may differ from a design flow 400 for designing a standard component. Design structure 420 is preferably an input to a design process 410 and may come from an IP provider, a core developer, or other design company or may be generated by the operator of the design flow, or from other sources. Design structure 420 comprises the circuits described above and shown in FIGS. 1 and 2 in the form of schematics or HDL, a hardware-description language (e.g., Verilog, VHDL, C, etc.). Design structure 420 may be contained on one or more machine readable medium. For example, design structure 420 may be a text file or a graphical representation of a circuit as described above and shown in FIGS. 1 and 2. Design process 410 preferably synthesizes (or translates) the circuits described above and shown in FIGS. 1 and 2 into a netlist 480, where netlist 480 is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist 480 is resynthesized one or more times depending on design specifications and parameters for the circuit.

Design process 410 may include using a variety of inputs; for example, inputs from library elements 430 which may house a set of commonly used elements, circuits, and devices, including models, layouts, and symbolic representations, for a given manufacturing technology (e.g., different technology nodes, 32 nm, 45 nm, 90 nm, etc.), design specifications 440, characterization data 450, verification data 460, design rules 470, and test data files 485 (which may include test patterns and other testing information). Design process 410 may further include, for example, standard circuit design processes such as timing analysis, verification, design rule checking, place and route operations, etc. One of ordinary skill in the art of integrated circuit design can appreciate the extent of possible electronic design automation tools and applications used in design process 410 without deviating from the scope and spirit of the invention. The design structure of the invention is not limited to any specific design flow.

Design process 410 preferably translates a circuit as described above and shown in FIGS. 1 and 2, along with any additional integrated circuit design or data (if applicable), into a second design structure 490. Design structure 490 resides on a storage medium in a data format used for the exchange of layout data of integrated circuits (e.g. information stored in a GDSII (GDS2), GL1, OASIS, or any other suitable format for storing such design structures). Design structure 490 may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIGS. 1 and 2. Design structure 490 may then proceed to a stage 495 where, for example, design structure 490: proceeds to tape-out, is released to manufacturing, is released to a mask house, is sent to another design house, is sent back to the customer, etc.

In the drawings and specifications there has been set forth a preferred embodiment of the invention and, although specific terms are used, the description thus given uses terminology in a generic and descriptive sense only and not for purposes of limitation.

What is claimed is:

1. A design structure embodied in a machine readable storage medium for at least one of designing, manufacturing, and testing a design, the design structure comprising:
an apparatus comprising:
a computer system central processor; and
layered memory operatively coupled to said central processor and accessible thereby, said layered memory having a level one cache;
said level one cache storing in interchangeable locations for both standard cache lines and trace lines, the storage of a trace line being delayed for a predetermined interval until such time as branch prediction is deemed sufficiently consistent.

2. The design structure according to claim 1, wherein the delay in storing trace lines is determined by the accumulation of a predetermined count of processor cycles.

3. The design structure according to claim 1, wherein the delay in storing trace lines is determined by the accumulation of a predetermined count of instruction(s) executed by said processor.

4. The design structure according to claim 1, wherein the delay in storing trace lines is determined by the state of a branch history table showing that a predetermined threshold of predictability has been attained.

5. The design structure according to claim 1, wherein the delay in storing trace lines is determined by recording the execution of branches and identifying when a sliding window of such executed branches reaches a predetermined threshold of correct predictions.

6. The design structure according to claim 1, wherein the delay in storing trace lines is determined by recording a cumulative score for the execution of branches, with the score increasing for each correct prediction and decreasing for each incorrect prediction, and identifying when that score reaches a predetermined threshold of correct predictions.

7. The design structure of claim 1, wherein the design structure comprises a netlist, which describes the apparatus.

8. The design structure of claim 1, wherein the design structure resides on the machine readable storage medium as a data format used for the exchange of layout data of integrated circuits.
